(19) United States
(12) Patent Application Publication
(10) Pub. No.: US 2026/0089210 A1
(43) Pub. Date: Mar. 26, 2026

(54) MANAGING HIGH-AVAILABILITY FILE SERVERS

(71) Applicant: Nutanix, Inc., San Jose, CA (US)

(72) Inventors: Tony JOSEPH, Bangalore (IN); Galaxy KADIYALA, Bangalore (IN)

(73) Assignee: Nutanix, Inc., San Jose, CA (US)

(21) Appl. No.: 18/222,987

(22) Filed: Jul. 17, 2023

Related U.S. Application Data
(63) Continuation of application No. 16/177,126, filed on Oct. 31, 2018, now Pat. No. 11,770,447.

(51) Int. Cl. H04L 67/1095; H04L 41/0803; H04L 67/06; H04L 67/1097

(52) U.S. Cl. CPC H04L 67/1095; H04L 41/0803; H04L 67/06; H04L 67/1097

(57) ABSTRACT

Methods, systems and computer program products for implementing high-availability file services in a clustered computing environment. Two or more clusters are interconnected to carry out operations for replication of file content between file servers. The file servers and their respective network links are registered with a file server witness. The file servers operate in synchrony, where each file I/O is replicated from one file server to another file server over a first set of network paths. A file server witness communicates with each file server using a second set of two or more network paths interfaced with respective file servers. The file server witness monitors the file servers to determine operational health of the file servers. Upon receipt of a file I/O request, the file I/O request is directed to one of the two file servers based at least in part on the determined operational health.

### RELATED APPLICATION

The present application is a continuation of U.S. patent application Ser. No. 16/177,126 titled “MANAGING HIGH-AVAILABILITY FILE SERVERS”, filed on Oct. 31, 2018, which is hereby incorporated by reference in its entirety.

### FIELD

This disclosure relates to distributed computing systems, and more particularly to techniques for managing high-availability file servers.

### BACKGROUND

As computing technologies have evolved, data has become more and more valuable. Accordingly, computer technologies have been developed that identify certain data to be “protected” so that it is accessible or available even in the presence of some disastrous event. For example, a backup system might be implemented to hold a copy of the data so that the copy can be accessed if the original data is damaged or destroyed (e.g., in a fire or computing system crash) or otherwise lost. Many variations of backup systems have been deployed. As an example, data comprising a hierarchy of files in a file system might be periodically written to some non-volatile storage (e.g., magnetic tape or other media) and stored at a second location so that the data can be restored if a disaster were to occur. This technique has the characteristic of requiring administrative intervention that incurs a relatively long “downtime” to restore the file system content from the backup media.

To address the long restore downtimes associated with such file system content, file systems are sometimes stored and managed in pairs of redundant file servers. Each of the file servers is often a dedicated computing entity (e.g., one or more workstations, one or more virtualized entities, etc.) that is configured to respond to requests for file access from various hosts, which hosts can be any computing entity in any location that is authorized to send and receive data to and from the file servers. By maintaining a redundancy between the pair of file servers, if one file server fails, then a second one of the redundant file servers can be consulted to access the file system content. The file server that failed can be brought back to an operational state (e.g., after remediation or replacement) and can then be synchronized with the second file server.

In certain situations, synchronous replication can be implemented at the two file servers. In synchronous replication, when a host machine issues a file input/output (I/O or IO) request to invoke a write to a first file server, the data of the write is written to the second file server before the first file server commits the write and acknowledges the write with the requesting host. As such, both the first file server and the second file server are always synchronized. However, in the event of a failure, for example, at the first file server, there is a certain period of time during which the file system content is unavailable while an administrator performs a cutover (e.g., failover) to the second file server. In computing environments that host mission critical applications or workloads, even moderately short periods of downtime (e.g., while an administrator performs a failover to the second file server) cannot be tolerated. These mission critical applications need to perform their mission critical tasks uninterrupted and without the need for administrative intervention.

Unfortunately, procedures for performing failovers from one file server to another redundant file server are deficient, at least with respect to providing uninterrupted availability of file system content. Specifically, such procedures involve manual administrator intervention, which results in at least some amount of time that the file system content is unavailable. Furthermore, certain portions of the data that comprises the file system content can be lost with some file server failover approaches. What is needed is a way to maintain lossless availability of file system content that is stored at two or more redundant file servers even in the presence of failures associated with one of the file servers.

### SUMMARY

The present disclosure describes techniques used in systems, methods, and in computer program products for managing high-availability file servers, which techniques advance the relevant technologies to address technological issues with legacy approaches. More specifically, the present disclosure describes techniques used in systems, methods, and in computer program products for fault tolerant access to file servers in multi-cluster computing environments. Certain embodiments are directed to technological solutions for implementing a high-availability file server capability by automatically directing file I/O requests to one of two or more synchronized file servers in accordance with the then-current status (e.g., health) of the file servers.

The disclosed embodiments modify and improve over legacy approaches. In particular, the herein-disclosed techniques provide technical solutions that address the technical problems attendant to maintaining lossless data availability for at least one file server in the presence of an access interruption that affects at least one of a plurality of synchronized file servers.

Further details of aspects, objectives, and advantages of the technological embodiments are described herein, and in the drawings and claims.

### BRIEF DESCRIPTION OF THE DRAWINGS

The drawings described below are for illustration purposes only. The drawings are not intended to limit the scope of the present disclosure.

FIG. 1A and FIG. 1B illustrate a computing environment in which embodiments of the present disclosure can be implemented.

FIG. 2 depicts a high-availability file server management technique as implemented in systems that facilitate fault tolerant access to file servers in multi-cluster computing environments, according to an embodiment.

FIG. 3 is a block diagram of a system that implements fault tolerant access to file servers in multi-cluster computing environments, according to an embodiment.

FIG. 4 presents a file server monitoring technique as implemented in systems that facilitate fault tolerant access to file servers in multi-cluster computing environments, according to an embodiment.

FIG. 5A depicts a file I/O request servicing technique as implemented in systems that facilitate fault tolerant access to file servers in multi-cluster computing environments, according to an embodiment.

FIG. 5B is a diagram that illustrates a connection resource management technique, according to an embodiment.

FIG. 6 depicts a file server synchronization technique as implemented in systems that facilitate fault tolerant access to file servers in multi-cluster computing environments, according to an embodiment.

FIG. 7A and FIG. 7B depict system components as arrangements of computing modules that are interconnected so as to implement certain of the herein-disclosed embodiments.

FIG. 8a, FIG. 8b, and FIG. 8c depict virtualized controller architectures comprising collections of interconnected components suitable for implementing embodiments of the present disclosure and/or for use in the herein-described environments.

### DETAILED DESCRIPTION

Embodiments in accordance with the present disclosure address the problem of maintaining lossless data availability for at least one file server in the presence of an access interruption that affects at least one of a plurality of synchronized file servers. Some embodiments are directed to approaches for implementing a high-availability file server capability by automatically directing file input/output (I/O or IO) requests to one of two or more synchronized file servers in accordance with the then-current status (e.g., health) of the file servers. The accompanying figures and discussions herein present example environments, systems, methods, and computer program products for fault tolerant access to file servers in multi-cluster computing environments.

### Overview

Disclosed herein are techniques for implementing a high-availability file server capability by automatically directing file I/O requests to one of two or more synchronized file servers in accordance with the then-current status (e.g., health) of the file servers. In certain embodiments, the file servers are implemented in respective clusters of a computing environment. The file servers are registered with a high-availability file server witness, which can be implemented in a cluster in the computing environment that is separate from the file server clusters. Status indicators (e.g., heartbeats) corresponding to the file servers are continually monitored by the high-availability file server witness. File I/O requests issued from various hosts to access the file system content at the file servers are directed to one of the file servers by the high-availability file server witness. The file server receiving a particular file I/O request is selected based at least in part on the current status indicators associated with the file servers. Any updates (e.g., in response to a file I/O write request) to the file system content at one file server is synchronized (e.g., replicated) at the other file servers. If a failure occurs at a file server that was earlier selected to service file I/O requests, the high-availability file server witness selects another file server to service incoming file I/O requests. When the failure is remediated, the file server that failed will be synchronized with any then-up-to-date file server(s).

In certain embodiments, the file servers and the high-availability file server witness are each implemented in separate availability zones and/or in separate failure domains. In certain embodiments, the file servers are implemented using one or more virtual machines. In certain embodiments, synchronous replication techniques and/or witness processes, and/or atomic operations facilitate synchronization of the file servers.

### Definitions and Use of Figures

Some of the terms used in this description are defined below for easy reference. The presented terms and their respective definitions are not rigidly restricted to these definitions—a term may be further defined by the term's use within this disclosure. The term “exemplary”is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale, and that elements of similar structures or functions are sometimes represented by like reference characters throughout the figures. It should also be noted that the figures are only intended to facilitate the description of the disclosed embodiments—they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiments even if not so illustrated. References throughout this specification to “some embodiments” or “other embodiments” refer to a particular feature, structure, material or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

### Descriptions Of Example Embodiments

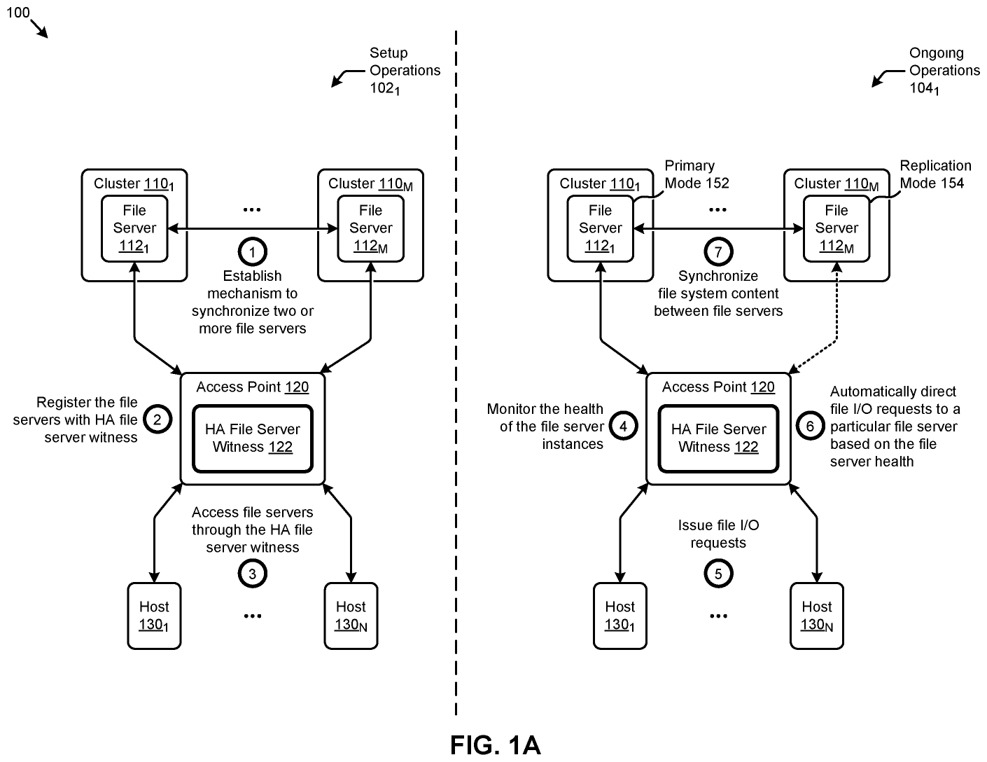

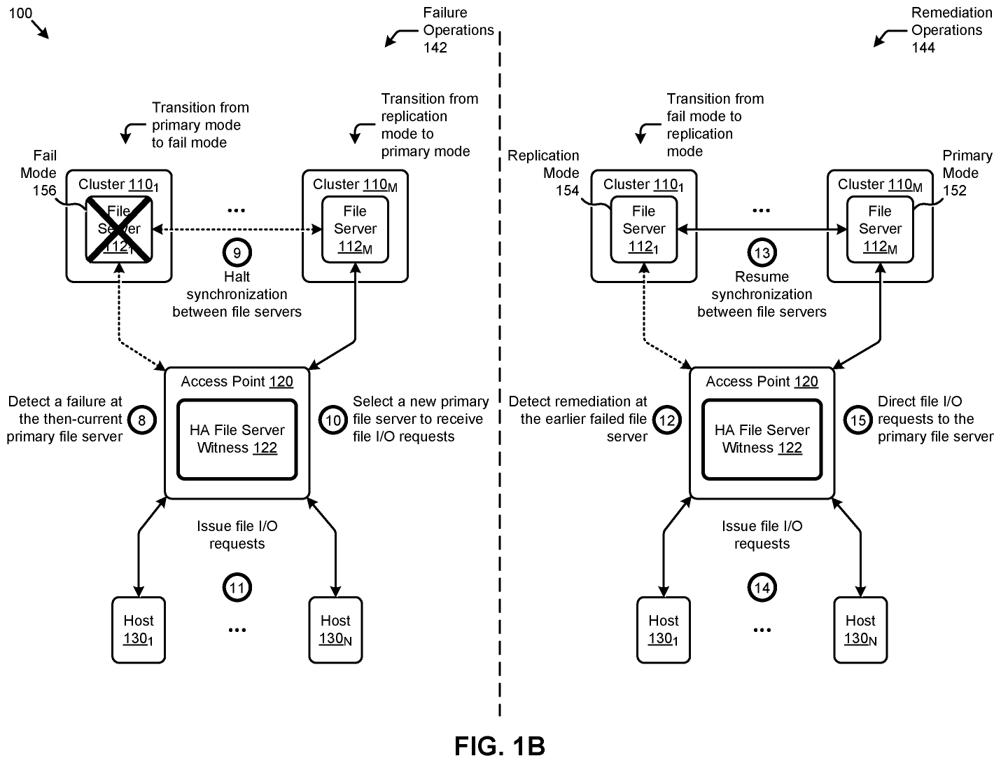

FIG. 1a and FIG. 1b illustrate a Computing Environment 100 in Which embodiments of the present disclosure can be implemented. As an option, one or more variations of computing environment 100 or any aspect thereof may be implemented in the context of the architecture and functionality of the embodiments described herein.

FIG. 1A and FIG. 1B illustrate aspects pertaining to implementing a high-availability file server capability by automatically directing file I/O requests to one of two or more synchronized file servers in accordance with the then-current status (e.g., health) of the file servers. Specifically, the figures present a logical depiction of how the herein disclosed techniques can be implemented and operated in a multi-cluster computing environment to facilitate high-availability access to file system content in the presence of various access interruptions that affect at least a portion of the computing entities (e.g., file servers) that are serving the content. The foregoing high-availability file server capability is illustrated in the figures by four representative sets of operations (e.g., setup operations 102₁, ongoing operations 104₁, failure operations 142, and remediation operations 144).

As indicated in the setup operations 102₁ of FIG. 1A, the herein disclosed techniques can be implemented in computing environment 100 by establishing a mechanism to synchronize two or more instances of file servers (operation 1). As shown, a file server 112₁ that is implemented in a cluster 110₁ and a file server 112_{M} that is implemented in a cluster 110M can be configured such that the file system content (e.g., files, folders, documents, content objects, etc.) served by each instance of the file servers are synchronized. As an example, a synchronous replication of the data of each file I/O operation might be configured so as to maintain synchronization between the file servers. More than two synchronized file servers are possible.

To facilitate the herein disclosed techniques, a witness node (e.g., HA file server witness 122) is implemented at an access point 120. As used herein, an access point is a set of computing resources (e.g., at a computing node in a cluster) selected to facilitate various inter-cluster management operations in a multi-cluster computing environment. For example, access point 120 might comprise a user interface that a system administrator can interact with to manage certain aspects (e.g., topology, operation, performance, etc.) of the multi-cluster environment.

Certain specialized processes and/or sets of programming code may also be implemented at access point 120 to carry out the inter-cluster management operations. For example, the capability of the HA file server witness 122 as described herein might be deployed as a set of programming code that is executed by the computing resources of access point 120. In some cases, the HA file server witness 122 and access point 120 are implemented in a cluster that is separate from cluster 110₁ and cluster 110_{M}. The file servers are registered with the HA file server witness 122 (operation 2) to facilitate access to the file servers by one or more hosts (e.g., host 130₁, . . . , host 130_{N}) through the HA file server witness 122 (operation 3). As earlier mentioned, such hosts can be any computing entity in any location that is authorized to send and receive data to and from the file servers. As an example, a host might be an application server which applications are used to manipulate certain objects included in the file system content stored at the file servers. In some cases, the registration of the file servers can, for example, establish certain profile data associated with the file servers that is maintained by the HA file server witness 122 to facilitate forwarding and/or processing of the incoming file I/O requests from the hosts.

As can be observed in the ongoing operations 104₁ of FIG. 1A, the HA file server witness 122 continually monitors the health of the file servers (e.g., file server 112₁, . . . , file server 112_{M}) (operation 4). For example, HA file server witness 122 might receive certain status indicators associated with file server 112₁ and file server 112_{M} from cluster 110₁ and cluster 110_{M} that indicate a healthy (e.g., operating as expected) file server, or an oversubscribed file server, or a file server failure, or a cluster failure, or a connection failure (e.g., between file servers, between clusters, between HA file server witness 122 and a file server, etc.). Other indicators of an unhealthy cluster and/or access path are possible.

Further, during ongoing operations 104₁ of FIG. 1A, the HA file server witness 122 continually monitors the health of network connections. For example, HA file server witness 122 might monitor a network interface, or a switch, or a router, or a network traffic load balancer, etc., to determine the health of the network connections as well as the status of the network connections based on any observations of then-current network traffic conditions.

As another example of health monitoring, the HA file server witness 122 might merely receive periodic “heartbeats” from the file servers. If the heartbeat corresponding to a particular file server were to cease, that would indicate the presence of some type of failure associated with the file server and/or its network connections.

As such, any file I/O requests issued by the hosts (operation 5) are directed by the HA file server witness 122 to a particular file server based at least in part on the then-current file server health (operation 6). If two or more of the file servers are healthy, the HA file server witness 122 will select one to take on the role of a primary file server and explicitly or implicitly designate the other healthy file servers as replication file servers. As a representative example in FIG. 1A, file server 112₁ is selected to operate in a primary mode 152 and, by default, becomes the first to receive file I/O requests from HA file server witness 122, while file server 112_{M} operates in a replication mode 154 and receives replication data from file server 112₁ to maintain synchronization between the file servers (operation 7). In some cases (e.g., with synchronous replication in an active-active configuration, etc.), the file servers achieve synchronization at each file I/O request. One technique to achieve synchronization at each file I/O request is to process I/Os serially, where a later I/O request is not started until the earlier I/O request has been completed at all file servers that are participating in an active-active configuration. As used herein, a file I/O request is a message transmitted over a network to perform one or more operations over the file system content stored at one or more file servers.

The format and/or structure of the file I/O request might depend on the file system implemented at the file servers and/or the mechanism implemented for accessing the file servers. For example, file I/O requests might be configured for Windows-based hosts to access server message block (SMB) file services provided by the file servers. In some embodiments, synchronization is implemented by the file servers at least in that the original recipient of a file I/O request will wait for acknowledgement of the completion of the file I/O request by its active-active peers before processing any further file I/O requests. As such, at the time that an indication of a completion of a particular file I/O request is returned to the requesting host, the file servers that are in active-active cooperation are already synchronized with respect to that particular file I/O.

Referring to the failure operations 142 of FIG. 1B, a failure associated with the then-current primary file server might be detected at HA file server witness 122 (operation 8). In the shown scenario, the failure might correspond to file server 112₁ at cluster 110₁, which transitions into a fail mode 156. In response to detecting the failure, HA file server witness 122 will communicate with one or more of the clusters to halt the synchronization between the file servers (operation 9). HA file server witness 122 will then select another file server to service incoming file I/O requests (operation 10). As shown, file server 112_{M} transitions to operate in primary mode 152. As such, and henceforth until remediation of the failed file server, the primary mode file server 112_{M} is the first receive file I/O requests issued by the hosts to the HA file server witness 122 (operation 11).

As depicted in remediation operations 144, when a failure remediation associated with an earlier failed file server is detected by HA file server witness 122 (operation 12), the HA file server witness 122 confirm readiness of the remediated file server to participate in active-active cooperation. When the HA file server witness 122 deems that the remediated file server can resume participation in active-active cooperation, the HA file server witness signals the remediated file server to transition from fail mode to replication mode. When the transition is complete (e.g., an acknowledgement is received by the HA file server witness) then a message is issued by HA file server witness 122 to the active-active file service participants instructing them to resume synchronization between themselves (operation 13).

New file I/O requests issued by the hosts (operation 14) are directed by the HA file server witness 122 to the file server (e.g., file server 112_{M}) selected to operate in primary mode 152 (operation 15). As a result of the performance of certain of failure operations 142 in combination with remediation operations 144, a lossless and uninterrupted availability of the file system content at the file servers is maintained even in the presence of an access interruption (e.g., file server failure, network path failure, etc.) that affects the synchronized file servers. As such, a high-availability file server capability in a multi-clustered computing environment is manifested.

The aforementioned high-availability file server capability facilitated by the herein disclosed techniques results in improvements in computer functionality that serve to reduce the demand for computer processing power, reduce the demand for computer memory and data storage, reduce network bandwidth use, and reduce the demand for inter-component communication in computing environments. Specifically, applications of the herein disclosed techniques reduce the consumption of computing resources by minimizing or eliminating the computing resources consumed by manual file server failover and failback operations as might be performed by an administrator. Still further, applications of the herein disclosed techniques reduce the consumption of computing resources by minimizing or eliminating the computing resources that would be consumed in the course of a manual file server failover and failback intervention at least in that, since the HA file server witness maintains a record of the completion of the last successful I/O operations, the synchronization that would occur in the course of remediation is limited to only those I/Os that had not been synchronized. As such, rollback to an older restore point is avoided, which avoidance saves significant CPU resources as well as networking resources.

One embodiment of techniques for managing such high-availability file server implementations is disclosed in further detail as follows.

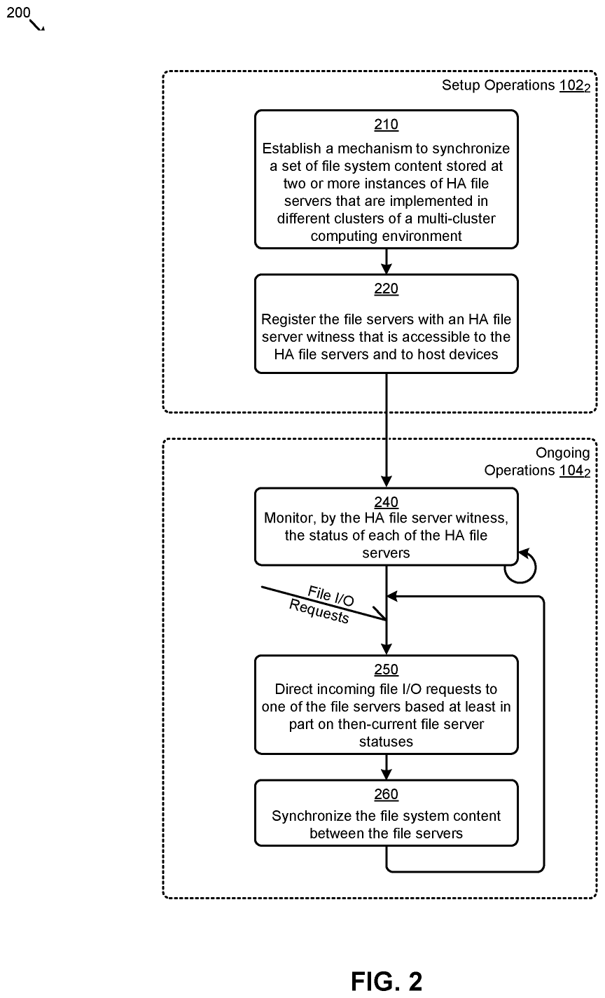

FIG. 2 depicts a high-availability file server management technique 200 as implemented in systems that facilitate fault tolerant access to file servers in multi-cluster computing environments. As an option, one or more variations of high-availability file server management technique 200 or any aspect thereof may be implemented in the context of the architecture and functionality of the embodiments described herein. The high-availability file server management technique 200 or any aspect thereof may be implemented in any environment.

FIG. 2 illustrates aspects pertaining to implementing a high-availability file server capability by automatically directing file I/O requests to one of two or more synchronized file servers in accordance with the then-current status (e.g., health) of the file servers. Specifically, the figure is presented to illustrate one embodiment of certain high order steps and/or operations that facilitate high-availability access to file system content in the presence of various access interruptions that affect at least a portion of the computing entities (e.g., file servers) that are serving the content. As can be observed, the steps and/or operations can be grouped into a set of setup operations 102₂ and a set of ongoing operations 104₂.

The setup operations 102₂ of the high-availability file server management technique 200 can commence by establishing a mechanism to synchronize the file system content stored at two or more instances of file servers that are implemented in respective clusters of a multi-cluster computing environment (step 210). One example mechanism might deploy synchronous replication techniques whereby a particular modification to the file system content (e.g., a file I/O write request) at a first file server is replicated to other file servers (e.g., a second file server) before the modification is acknowledged as complete and/or committed. Such synchronous replication techniques facilitate lossless content availability if a failover from the first file server to one of the other file servers were to occur. The set of synchronized file servers are registered with a high-availability (HA) file server witness that is implemented in a respective cluster in the multi-cluster computing environment (step 220). In this case, the HA file server witness is in a separate cluster from the clusters hosting their respective file servers. Registering the file servers with an HA file server witness facilitates communications between the HA file server witness and the file servers.

In one specific embodiment, upon registering the file servers with the HA file server witness, specialized connection resources (e.g., high-performance, secure socket connections) are established. A data structure that captures the existence and status of such specialized connection resources is populated at the HA file server witness. The specialized connection resources can be used by any of the hosts that raise I/O requests. More specifically, in certain cases of file I/O, an I/O request might specify a large data extent (e.g., to copy a large file). As such, a high-performance, secure socket connection facilitates accomplishment of the communication of the contents of the large data extent. In many cases, I/O requests raised by a host and received at the HA file server witness are redirected by the HA file server witness back to the requestor together with an indication of a connection resource to be used by the host for carrying out the movement of file data corresponding to the I/O request. During carrying out of the movement of file data corresponding to the I/O request, the HA file server witness continues ongoing operations such as monitoring and tracking of file server profile data.

In particular, the ongoing operations 104₂ of the high-availability file server management technique 200 including monitoring the status of each of the file servers (step 240). As illustrated in FIG. 2, the monitoring operations are continuous operations that produce, for example, one or more status indicators corresponding to the file servers that can be accessed by the HA file server witness. As earlier mentioned, such status indicators might indicate a healthy (e.g., operating as expected) file server, or might indicate an oversubscribed file server, or a file server failure, or a cluster failure, or a connection failure (e.g., between file servers, between clusters, between the HA file server witness and a file server, etc.). Other indicators of an unhealthy cluster are possible.

The status indicators might also correspond to “heartbeats” from the file servers. In response to file I/O requests from one or more hosts to access the file system content at the file servers, the file I/O requests are directed to one of the file servers based at least in part on the then-current file server status and/or other environmental conditions (step 250). If the then-current file server status indicates two or more of the file servers and their respective network connections are healthy, then the file I/O requests will be directed to a file server selected as the primary file server. If the then-current file server status indicates the primary file server has incurred some failure or is not reachable over the network connections, or is otherwise unhealthy, a new primary file server is selected from the healthy file servers to receive the file I/O requests.

At step 260, the file system content is synchronized between the file servers. If all file servers are healthy, the file system content at each of the file servers is synchronized at each file I/O request according to synchronous replication techniques. Any unhealthy (e.g., failed) file servers will be updated with all file system content changes incurred since failure once the file servers achieve a healthy status.

One embodiment of a system, data flows, and data structures for implementing the high-availability file server management technique 200 and/or other herein disclosed techniques is disclosed as follows.

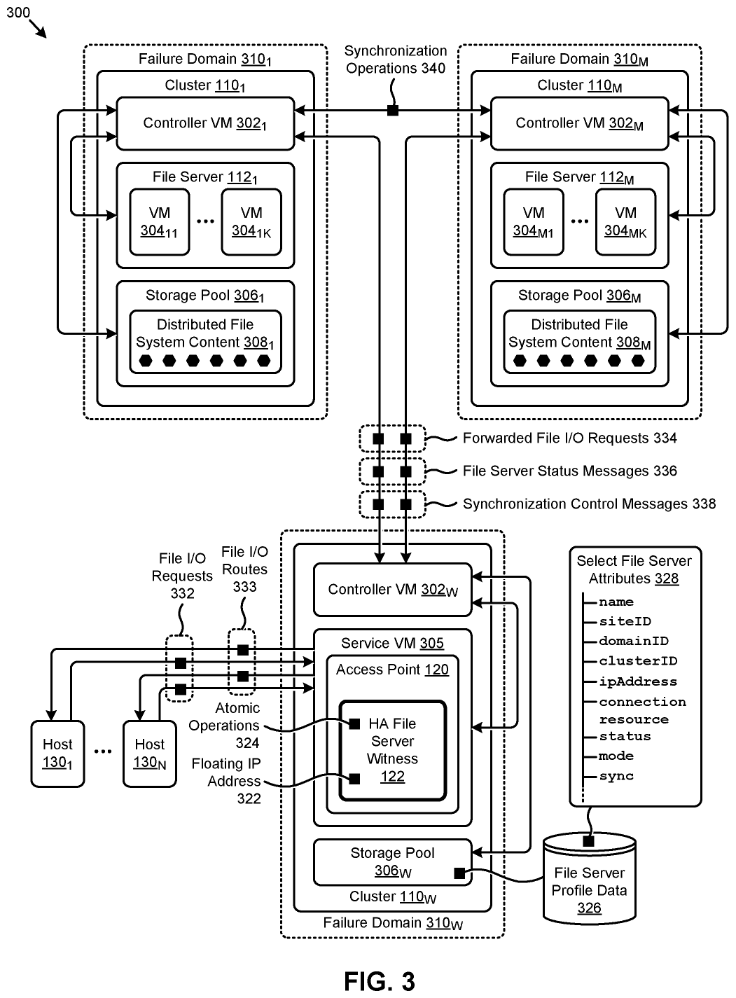

FIG. 3 is a block diagram of a system 300 that implements fault tolerant access to file servers in multi-cluster computing environments. As an option, one or more variations of system 300 or any aspect thereof may be implemented in the context of the architecture and functionality of the embodiments described herein. The system 300 or any aspect thereof may be implemented in any environment.

FIG. 3 illustrates aspects pertaining to implementing a high-availability file server capability by automatically directing file I/O requests to one of two or more synchronized file servers in accordance with the then-current status (e.g., health) of the file servers. Specifically, the figure is being presented to show one embodiment of certain representative components and associated data flows that describes how the herein disclosed techniques might be implemented in a modern multi-cluster computing environment. The components and data flows shown in FIG. 3 present one partitioning and associated data manipulation approach. The specific example shown is purely exemplary, and other subsystems, data structures, and/or partitioning are reasonable.

As shown in FIG. 3, the system 300 comprises at least two file servers (e.g., file server 112₁ and file server 112_{M}) implemented in respective clusters (e.g., cluster 110₁ and cluster 110_{M}). The file servers can be implemented at the clusters using one or more virtual machines (VMs). For example, file server 112₁ comprises VM 304₁₁ through VM 304_{1K} at cluster 110₁, and file server 112_{M} comprises VM 304_{M1} through VM 304_{MK} at cluster 110_{M}. A controller VM 302₁ and a controller VM 302_{M} are implemented at cluster 110₁ and cluster 110_{M}, respectively to facilitate I/O operations between the file server VMs and respective storage pools (e.g., storage pool 306₁ and storage pool 306_{M}) at the clusters. The controller VMs also facilitate inter-cluster communications and/or other operations.

The computing resources underlying the VMs and the storage facilities comprising the storage pools correspond to one or more computing nodes associated (e.g., logically and/or physically) with the clusters. The storage facilities of the storage pools can comprise multiple tiers of storage distributed over the nodes in the clusters. The multiple tiers of storage can include local storage which can be within or directly attached to a server and/or appliance associated with the nodes. Such local storage can include solid state drives (SSDs), hard disk drives (HDDs), and/or other storage devices. In some embodiments, the multiple tiers of storage can include storage that is accessible through an external network, such as a networked storage (e.g., a storage area network or SAN, network attached storage or NAS, etc.).

As can be observed, instances of the file system content associated with each file server (e.g., distributed file system content 308₁ and distributed file system content 308_{M}) can be distributed over the multiple tiers of storage that comprise the respective storage pools (e.g., storage pool 306₁ and storage pool 306_{M}). To facilitate the herein disclosed techniques, controller VM 302₁ of cluster 110₁ and controller VM 302_{M} of cluster 110_{M} can interact to perform various instances of synchronization operations 340 that maintain synchronization between the distributed file system content 308₁ and the distributed file system content 308_{M}.

To also facilitate the herein disclosed techniques, an instance of the HA file server witness 122 can operate at an access point 120 which can in turn operate at a service VM 305 implemented in another cluster (e.g., cluster 110_{W}) in the multi-cluster computing environment. As can be observed, the service VM 305 might serve as the access point 120 for the multi-cluster computing environment. As used herein, an access point is a set of resources (e.g., virtualized entity, VM, executable container, etc.) in a cluster selected to facilitate various intra-cluster and/or inter-cluster operations. In some cases, an access point 120 can be implemented to serve a particular role (e.g., cluster management, multi-cluster management, multi-region or multi-site management, etc.). The access point 120, for example, might be implemented to facilitate management of the clusters comprising system 300.

A controller VM 302_{W} is also deployed at cluster 110_{W} to manage access to a storage pool 306_{W} at the cluster and to facilitate interactions with the controller VMs of the clusters hosting the file servers and/or any other clusters in system 300. Furthermore, cluster 110_{W} is associated with a failure domain 310_{W}, whereas cluster 110₁ is associated with a failure domain 310₁ and cluster 110_{M} is associated with a failure domain 310_{M}. As used herein, a failure domain or availability domain is logical collection of hardware components (e.g., nodes, switches, racks, etc.) that are affected by failures within the collection. As an example, a failure domain might comprise a single physical node appliance or a rack of node appliances that comprise a cluster. As additional examples, a failure domain might comprise a set of computing components that are powered by the same alternating current (AC) to direct current (DC) power supply. The separate failure domains of cluster 110₁, cluster 110_{M}, and cluster 110_{W} are drawn to indicate that a failure in a particular cluster will not affect any other clusters.

According to the herein disclosed techniques, the HA file server witness 122 might receive certain registration information from file server 112₁ and file server 112_{M} (e.g., through the respective controller VMs at the clusters). The registration information can be used to establish various collections of file server profile data 326 corresponding to the registered file servers. The file server profile data 326 and/or any other data described herein can be organized and/or stored using various techniques. For example, a set of select file server attributes 328 indicate that the file server profile data 326 might be organized and/or stored in a tabular structure (e.g., relational database table) that has rows that relate various user attributes with a particular file server.

As another example, the information might be organized and/or stored in a programming code object (not shown, for simplicity) that has instances corresponding to a particular file server and properties corresponding to the various attributes associated with the file server. As depicted in select file server attributes 328, a data record (e.g., table row or object instance) for a particular file server might describe a file server name (e.g., stored in a “name” field), a site identifier (e.g., stored in a “siteID” field), a failure domain identifier (e.g., stored in a “domainID” field), a cluster identifier (e.g., stored in a “clusterID” field), a file server URL or IP address (e.g., stored in an “ipAddress” field), a connection resource (e.g., stored in a “connectionResource” field), a file server status indicator (e.g., stored in a “status” field), a file server operational mode (e.g., stored in a “mode” field), a file server synchronization status (e.g., stored in a “sync”field), and/or other file server attributes.

Certain portions of the file server attributes stored in file server profile data 326 are static, while other portions of the attributes change over time. As an example, file server monitoring operations might generate instances of file server status messages 336 that are received by HA file server witness 122 through controller VM 302_{W}. Such messages might comprise certain status indicators associated with the file servers that are codified (e.g., in the “status” fields) of respective instances of file server profile data 326.

The then-current status information can be accessed to facilitate certain techniques disclosed herein. Specifically, when instances of file I/O requests 332 are received from various hosts (e.g., host 130₁, . . . , host 130_{N}) at the HA file server witness 122, the then-current status information at the file server profile data 326 is accessed to facilitate directing the file I/O requests 332 to one of the file servers. Instances of forwarded file I/O requests 334 that correspond to the file I/O requests 332 are issued to a selected one of the file servers through the controller VMs at the clusters. For example, a file I/O request from host 130₁ that merely updates a file system directory or metadata entry might be forwarded by HA file server witness 122 to file server 112₁ without being redirected. However, when a file I/O request from host 130₁ calls for large amount of data to be read from or written to distributed file system content 308₁, the I/O request or portion thereof might be redirected by HA file server witness 122 to the requestor. In some embodiments, the HA file server witness is configured to make a determination as to whether to complete the requested I/O with the target file server (e.g., in the case of a small I/O request), or whether to redirect the I/O back to the requestor to have the requestor complete the requested I/O with the target file server (e.g., in the case of a large I/O request). In some embodiments, the HA file server witness is configured to identify one or more file I/O routes 333 and one or more corresponding connection resources prior to redirecting the I/O back to the requestor.

As previously indicated, the active-active file servers implement synchronous replication of the data for each file I/O operation. For example, before a write is committed at distributed file system content 308₁ and completion of the file I/O write is acknowledged to the requesting host 130₁, one or more synchronization operations 340 are issued to file server 112_{M} to perform a replica of the write operation at distributed file system content 308_{M}. The synchronization statuses of the file servers participating in the foregoing synchronization process are communicated to the HA file server witness 122 (e.g., for recording in the file server profile data 326) using one or more atomic operations 324. The atomic operations 324 (e.g., using semaphores and/or compare and swap techniques) ensure that synchronization is achieved even in the presence of various failures associated with the file servers. For example, the atomic operation guarantees that only the first one of multiple compare-and-swap operations result in an ownership or leadership determination, whereas the Nth, not first ones of multiple compare-and-swap operations result in agreement that there has already been one owner or leader established. In some cases, the atomic operations serve to establish a quorum from among a set of active-active HA file servers. In some cases, the atomic operations serve to establish a primary mode file server from among a set of active-active HA file servers.

Further details regarding atomic operations and use of quorums are described in U.S. application Ser. No. 16/041,348 titled “TWO NODE CLUSTERS RECOVERY ON FAILURE”, filed on Jul. 20, 2018, which is hereby incorporated by reference in its entirety.

When a failure is detected at one or more of the file servers and/or at one or more of the communication links between the file servers and the HA file server witness 122, various remediation actions are taken. As one example, one or more synchronization control messages 338 might be issued from HA file server witness 122 to one or more of the file servers. Such synchronization control messages might be issued to halt or resume synchronization between the file servers. The HA file server witness 122 might also deploy a floating IP address 322 that is mapped to a physical (e.g., dotted quads) or virtual IP address of the one file server (e.g., the primary file server) that is selected to first receive instances of the forwarded file I/O requests 334. In some cases, the HA file server witness 122 might further modify the operating modes (e.g., primary mode, replication mode, etc.) of one or more of the file servers in response to changing conditions. For example, in the event that a first network path to a first file server becomes congested or is otherwise deemed to be slower than a second network path to a second file server, then the HA file server witness might instruct the second file server to take-on the role of primary file server.

In some implementations, the HA file server witness might include mode instructions and/or mode indications (e.g., primary mode, replication mode, etc.) together with each forwarded file I/O request. In some implementations, a synchronization control message might include an indication that the receiving file server is to operate in primary mode for the corresponding file I/O. In some cases, operation in primary mode by a receiving file server is inherent based on the network connection over which a file I/O request is received.

The foregoing discussions include techniques for monitoring the status (e.g., health) of a set of synchronized file servers (e.g., step 240 of FIG. 2), which techniques are disclosed in further detail as follows.

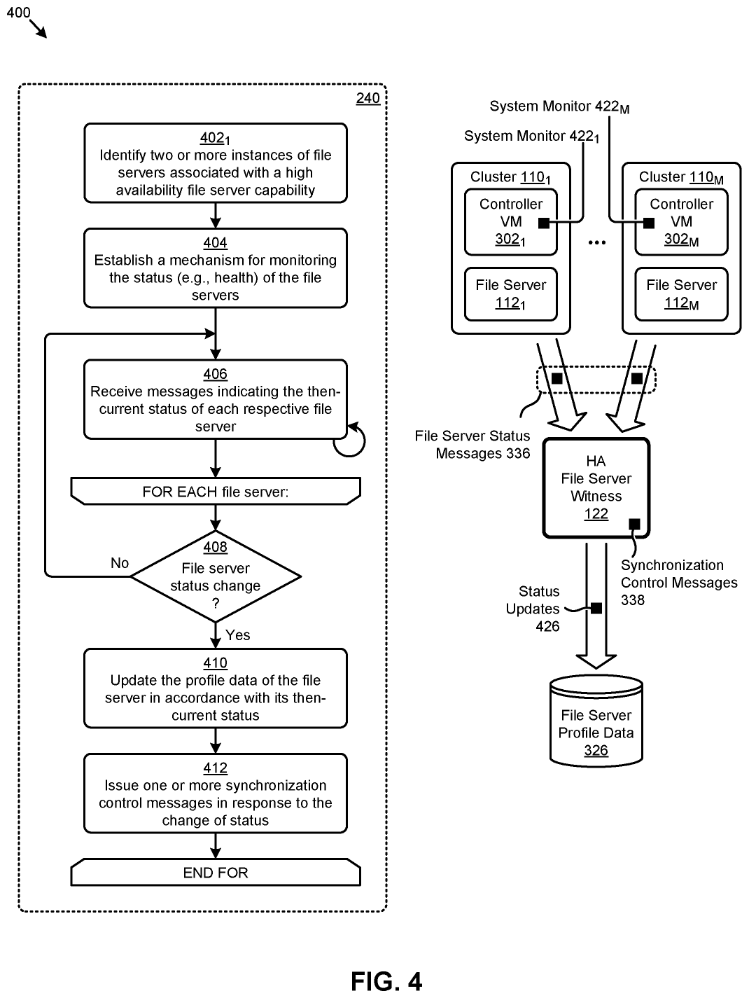

FIG. 4 presents a file server monitoring technique 400 as implemented in systems that facilitate fault tolerant access to file servers in multi-cluster computing environments. As an option, one or more variations of file server monitoring technique 400 or any aspect thereof may be implemented in the context of the architecture and functionality of the embodiments described herein. The file server monitoring technique 400 or any aspect thereof may be implemented in any environment.

FIG. 4 illustrates aspects pertaining to implementing a high-availability file server capability by automatically directing file I/O requests to one of two or more synchronized file servers in accordance with the then-current status (e.g., health) of the file servers. Specifically, the figure is presented to illustrate one embodiment of certain steps and/or operations that facilitate monitoring the status (e.g., health) of two or more synchronized file servers in a multi-cluster computing environment. A representative scenario is also shown in the figure to illustrate an example application of the file server monitoring technique 400.

The file server monitoring technique 400 can commence by identifying two or more instances of file servers that are associated with a high-availability file server capability (step 402₁). As illustrated, a file server 112₁ at cluster 110₁ and a file server 112_{M} at cluster 110_{M} might be synchronized and managed in accordance with the herein disclosed techniques to deliver the high-availability file server capability. A mechanism for monitoring the status (e.g., operational status, health, etc.) of the file servers is established (step 404). For example, sets of programming code to execute system monitoring operations over the file servers might be implemented in the clusters comprising the file servers. As shown in FIG. 4, system monitors (e.g., system monitor 422₁ and system monitor 422_{M}) might be deployed in the controller VMs (e.g., controller VM 302₁ and controller VM 302_{M}) of the clusters associated with the file servers. Messages that indicate the then-current status of each respective file server are received (step 406). Such messages (e.g., file server status messages 336) might be issued from the system monitors and received by an instance of the HA file server witness 122. As indicated in FIG. 4, the messages are continually received (e.g., in accordance with various schedules or events).

For each of the file servers, if one or more file server status messages associated with the file server indicate there is no change to the status of the file server (see “No” path of decision 408), then the process continues to listen for additional file server status messages (step 406). If a change to the file server status is detected (see “Yes” path of decision 408), then the profile data associated with the file server is updated in accordance with the then-current status of the file server (step 410). For example, HA file server witness 122 might execute one or more status updates 426 to the file server profile data 326 in response to detecting one or more file server status changes as indicated in one or more file server status messages. In some cases, one or more synchronization control messages might be issued in response to a status change (step 412). As an example, one or more synchronization control message 338 might be issued by HA file server witness 122 to halt synchronization if the status of one of the file servers changed from healthy to failed.

The foregoing discussions include techniques for servicing (e.g., directing, forwarding, routing, processing, etc.) file I/O requests issued to operate over the file system content associated with a high-availability file server capability (e.g., step 250 of FIG. 2), which techniques are disclosed in further detail as follows.

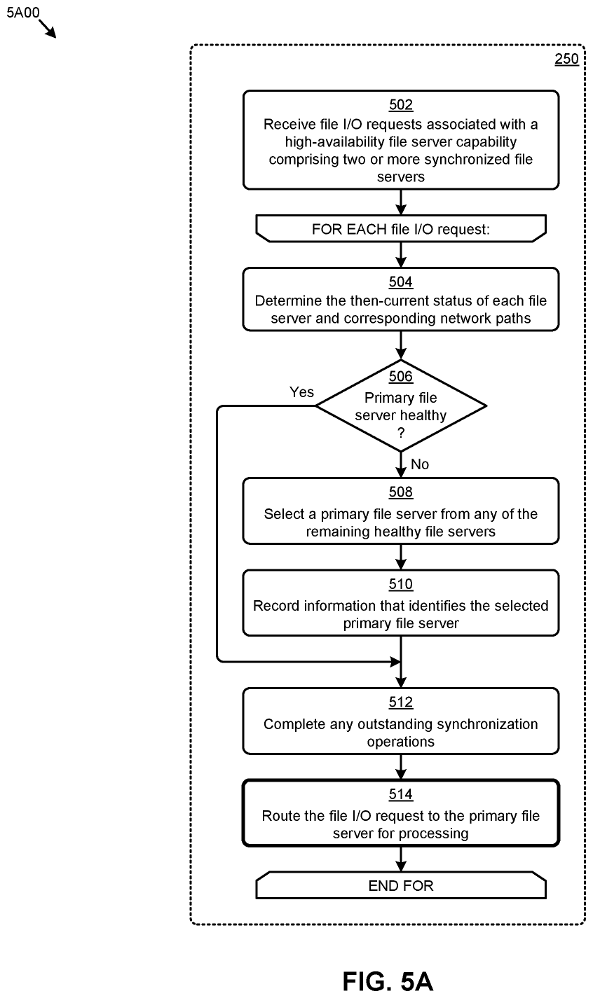

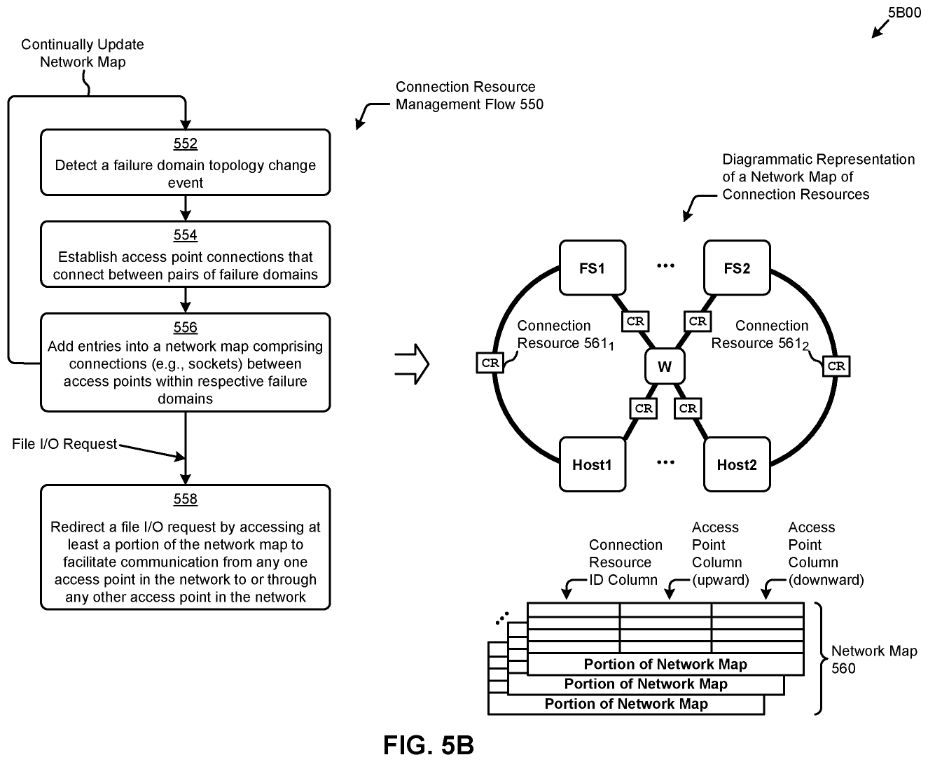

FIG. 5A depicts a file I/O request servicing technique 5A00 as implemented in systems that facilitate fault tolerant access to file servers in multi-cluster computing environments. As an option, one or more variations of file I/O request servicing technique 5A00 or any aspect thereof may be implemented in the context of the architecture and functionality of the embodiments described herein. The file I/O request servicing technique 5A00 or any aspect thereof may be implemented in any environment.

FIG. 5A illustrates aspects pertaining to implementing a high-availability file server capability by automatically directing file I/O requests to one of two or more synchronized file servers in accordance with the then-current status (e.g., health) of the file servers. Specifically, the figure is presented to illustrate one embodiment of certain steps and/or operations that facilitate the automatic directing or other servicing of the file I/O requests issued to operate over the file system content associated with the file servers based at least in part on the then-current status of the file servers.

The file I/O request servicing technique 5A00 can commence by receiving one or more file I/O requests associated with a high-availability file server capability that is facilitated at least in part by two more synchronized file servers (step 502). To process each of the file I/O requests received, the then-current status of the file servers comprising the high-availability file server capability is determined (step 504). For example, the file server profile data described earlier might be accessed to determine the then-current file server status. Additionally, or alternatively, step 504 might include determinations of the health and/or traffic conditions, and/or over-or under-subscription of network paths used by the file servers.

If the then-current primary file server is not healthy according to the then-current status (see “No” path of decision 506), then a primary file server is selected from the remaining healthy file servers from the synchronized file servers (step 508). In situations where the high-availability file server capability is implemented by a pair of synchronized file servers, merely one remaining healthy file server might be available for selection as the primary file server. In other cases, various selection techniques (e.g., random, round robin, etc.) might be applied to select a primary file server from a plurality of healthy file servers. Certain information that identifies the selected file server as the primary file server is recorded (step 510). As an example, a “mode” field in the earlier mentioned file server profile data might associate a “primary mode” with a particular file server selected to serve as the primary file server.

Having newly selected a healthy primary file server or determined that an earlier selected primary file server is healthy (see “Yes” path of decision 506), any outstanding synchronization operations are then completed at all healthy file servers (step 512). For example, in synchronous replication implementations, any synchronous operations corresponding to an earlier received file I/O request are completed at all participating file servers (e.g., healthy file servers) before a further file I/O request is processed. In some cases, all synchronization operations might be earlier or concurrently halted by another process (e.g., the file server monitoring technique 400 of FIG. 4) in response to, for example, a file server status change (e.g., from healthy to failed).

When all synchronization operations are completed (or halted), the file I/O request is routed to the primary file server for processing (step 514). In some cases, such file I/O request routing (e.g., directing, forwarding, etc.) might be facilitated by mapping a floating IP address to a file server IP address.

In some embodiments, the file I/O request routing employs a technique for managing a set of connection resources that facilitate high-performance and secure communications between network-interconnected failure domains. More specifically, step 514 can be implemented in whole or in part by a connection resource management technique such as is shown and described as pertains to FIG. 5B.

FIG. 5B is a diagram that illustrates a connection resource management technique 5B00. The diagram shows maintaining and using connection resources between network-interconnected failure domains. Such connection resources may be used to implement a high-availability file server capability.

The technique operates by mapping file I/O requests to connection resources that in turn are used to facilitate network I/O between one of two or more synchronized file servers. More specifically, and as depicted by shown connection resource management flow 550, the flow continuously monitors changes to the network topology and responds to changes by establishing and maintaining a network map of connection resources. As illustrated, the connection resource network mapping flow commences by detecting a failure domain topology change event (step 552). For example, a failure domain topology change event might be triggered by a registry change (e.g., a new host added into a failure domain) or a topology change (e.g., the boundary of a failure domain is redrawn). Responsive to the event, various access points in the environment are identified, and certain pairs of access points in the various failure domains are selected (step 554). Connections (e.g., connection resource 561₁, connection resource 561₂, etc.) are established between access points of the selected pairs. Once the connections are verified to be operational and have been authenticated, step 556 serves to populate a network map by adding entries to data structures comprising characteristics (e.g., secure socket descriptions) of the authenticated connections.

A schematic diagram of a network map of connection resources is shown. As can be observed, the network map can be continually updated by listening for and detecting failure domain topology change events.

At any moment in time, portions of the then-current network map are used to facilitate communication from any one access point in the network to or through any other access point in the network (step 558). For example, using the network map 560 or a portion thereof, host “Host1” can communicate with file server “FS1” directly using connection resource 561₁. Similarly, using the network map 560 or a portion thereof, host “Host2” can communicate with file server “FS2” directly using connection resource 561₂. Alternatively, or additionally, host “Host1” can communicate with file server “FS1” and/or file server “FS2” by routing through witness “W”. In some cases, two or more file servers (e.g., file server “FS1”, file server “FS2”, etc.) can carry out ongoing synchronization between themselves using a connection resource.

The foregoing discussions include techniques for synchronizing the file system content of two or more file servers associated with a high-availability file server capability (e.g., step 260 of FIG. 2), which techniques are disclosed in further detail as follows.

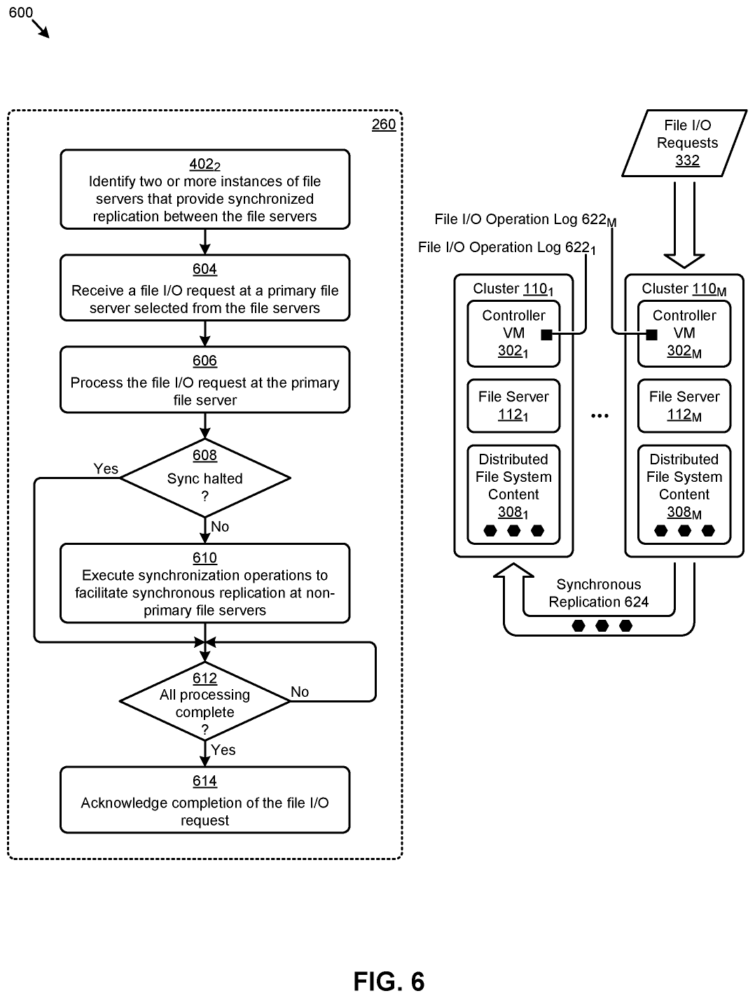

FIG. 6 depicts a file server synchronization technique 600 as implemented in systems that facilitate fault tolerant access to file servers in multi-cluster computing environments. As an option, one or more variations of file server synchronization technique 600 or any aspect thereof may be implemented in the context of the architecture and functionality of the embodiments described herein. The file server synchronization technique 600 or any aspect thereof may be implemented in any environment.

FIG. 6 illustrates aspects pertaining to implementing a high-availability file server capability by automatically directing file I/O requests to one of two or more synchronized file servers in accordance with the then-current status (e.g., health) of the file servers. Specifically, the figure is presented to illustrate one embodiment of certain steps and/or operations that facilitate synchronization of instances of a set of file system content stored at two or more file servers according to a synchronous replication approach. A representative scenario is also shown in the figure to illustrate an example application of the file server synchronization technique 600.

The file server synchronization technique 600 can commence by identifying two or more instances of file servers that are associated with a high-availability file server capability (step 402₂). As illustrated, a file server 112₁ at cluster 1101 and a file server 112_{M} at cluster 110_{M} might be implemented to deliver the high-availability file server capability in accordance with the herein disclosed techniques. As such, a respective instance of a set of file system content (e.g., distributed file system content 308₁ and distributed file system content 308_{M}) is managed by each file server. When a file I/O request is received at a primary file server selected from the file servers (step 604), the file I/O request is processed at the primary file server (step 606). As an example, a particular file I/O request from the file I/O requests 332 might be received at file server 112_{M} (e.g., the primary file server).

There are many reasons why synchronization between the file servers might be halted. For example, it can happen that communications between the file servers are interrupted or, it can happen that the file server witness to which the filer servers are registered has determined that a failover should be commenced, for example due to a health status. A halt indication can be raised by any component of the system. In exemplary embodiments, a halt indication is raised by a file server witness in response to a determination that one of the file servers and/or its communication links are no longer sufficiently healthy to continue serving as a synchronized file server.

If synchronization is halted (see “Yes” path of decision 608), the ongoing synchronization efforts are abandoned, and processing control passes to steps that complete currently in-process I/Os. However. if synchronization is not halted (see “No” path of decision 608), then one or more synchronization operations are executed to facilitate synchronous replication at any file servers that are not the then-current primary file servers (e.g., non-primary file servers). As earlier described, such synchronization operations might be facilitated by the controller VMs (e.g., controller VM 302₁ and controller VM 302_{M}) at the clusters hosting the file servers. More specifically, in the case of a file I/O write request, when data associated with the request is written to file I/O operations log 622_{M} associated with the primary file server, the same data is synchronously replicated to the file I/O operations log 622₁ of any other file servers comprising the set of two or more file servers.

More particularly, each of the aforementioned file I/O operations logs comprise all file I/Os that have been received at a respective controller VM. As such, the contents of one log (e.g., file I/O operations log 622₁) can be compared with another log (e.g., file I/O operations log 622₁) to determine which I/Os need to be applied to which file servers in order to become synchronized. A process to synchronize all file servers in an HA group can be invoked at any time, and more particularly, at a moment in time after remediation. In the example of FIG. 6, synchronization after remediation occurs during performance of step 610.

When all file I/O processing at all file servers is complete (see “Yes” path of decision 612), a successful completion of the file I/O request is acknowledged (step 614) and a synchronous replication 624 between the file servers (e.g., file server 112₁ and file server 112_{M}) is achieved. If the file I/O processing is not complete (see “No” path of decision 612), the file server synchronization technique 600 will continue to wait for completion of the file I/O request before acknowledging that the file I/O request has been successfully completed.

### Additional Embodiments Of The Disclosure

### Additional Practical Application Examples

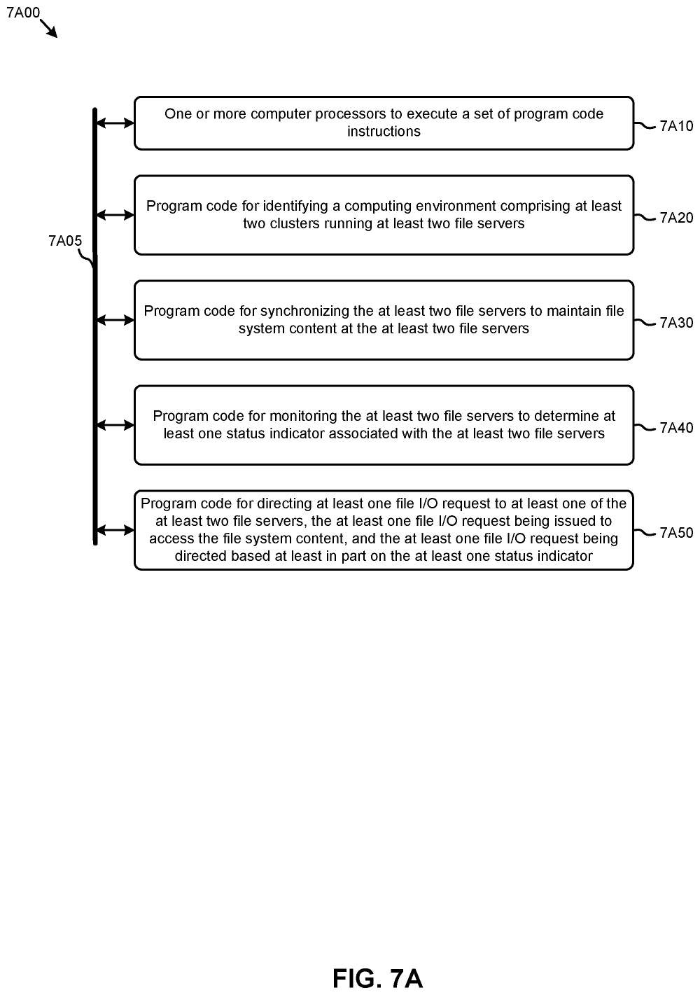

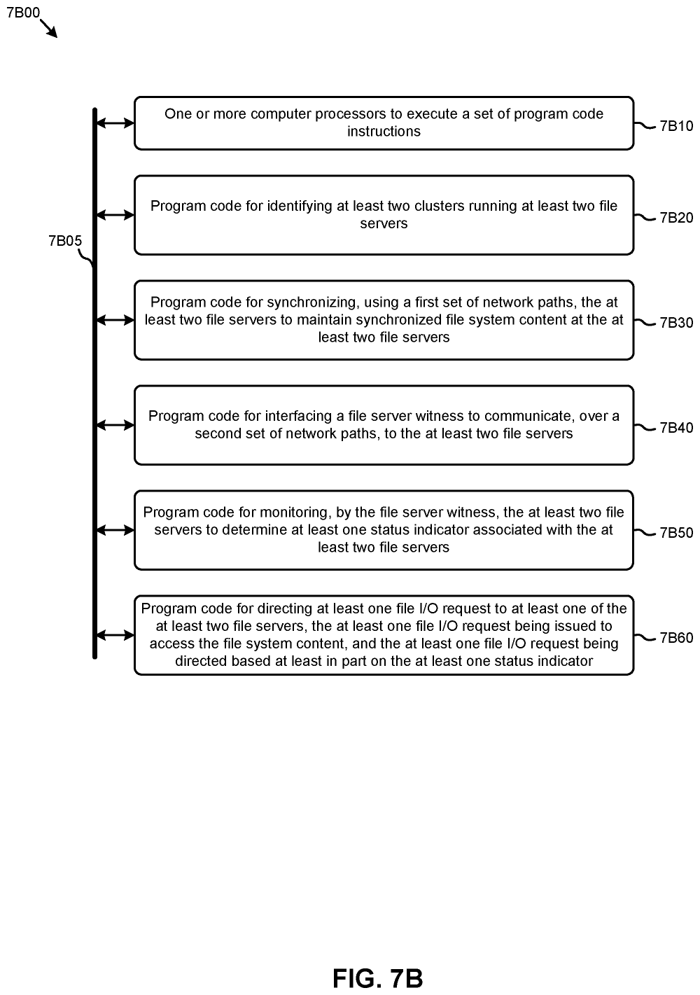

FIG. 7A depicts a system 7A00 as an arrangement of computing modules that are interconnected so as to operate cooperatively to implement high-availability file servers. This and other embodiments present particular arrangements of elements that, individually or as combined, serve to form improved technological processes that address maintaining lossless data availability for at least one file server in the presence of an access interruption that affects at least one of a plurality of synchronized file servers. The partitioning of system 7A00 is merely illustrative and other partitions are possible. As an option, the system 7A00 may be implemented in the context of the architecture and functionality of the embodiments described herein. Of course, however, the system 7A00 or any operation therein may be carried out in any desired environment.

The system 7A00 comprises at least one processor and at least one memory, the memory serving to store program instructions corresponding to the operations of the system. As shown, an operation can be implemented in whole or in part using program instructions accessible by a module. The modules are connected to a communication path 7A05, and any operation can communicate with any other operations over communication path 7A05. The modules of the system can, individually or in combination, perform method operations within system 7A00. Any operations performed within system 7A00 may be performed in any order unless as may be specified in the claims.

The shown embodiment implements a portion of a computer system, presented as system 7A00, comprising one or more computer processors to execute a set of program code instructions (module 7A10) and modules for accessing memory to hold program code instructions to perform: identifying a computing environment comprising at least two clusters running at least two file servers (module 7A20); synchronizing the at least two file servers to maintain file system content at the at least two file servers (module 7A30); monitoring the at least two file servers to determine at least one status indicator associated with the at least two file servers (module 7A40); and directing at least one file I/O request to at least one of the at least two file servers, the at least one file I/O request being issued to access the file system content, and the at least one file I/O request being directed based at least in part on the at least one status indicator (module 7A50).

Variations of the foregoing may include more or fewer of the shown modules. Certain variations may perform more or fewer (or different) steps and/or certain variations may use data elements in more or in fewer (or different) operations. Still further, some embodiments include variations in the operations performed, and some embodiments include variations of aspects of the data elements used in the operations.

FIG. 7B depicts a system 7B00 as an arrangement of computing modules that are interconnected so as to operate cooperatively to implement certain of the herein-disclosed embodiments. The partitioning of system 7B00 is merely illustrative and other partitions are possible. As an option, the system 7B00 may be implemented in the context of the architecture and functionality of the embodiments described herein. Of course, however, the system 7B00 or any operation therein may be carried out in any desired environment.

The system 7B00 comprises at least one processor and at least one memory, the memory serving to store program instructions corresponding to the operations of the system. As shown, an operation can be implemented in whole or in part using program instructions accessible by a module. The modules are connected to a communication path 7B05, and any operation can communicate with any other operations over communication path 7B05. The modules of the system can, individually or in combination, perform method operations within system 7B00. Any operations performed within system 7B00 may be performed in any order unless as may be specified in the claims.

The shown embodiment implements a portion of a computing environment, presented as system 7B00, comprising one or more computer processors to execute a set of program code instructions (module 7B10) and modules for accessing memory to hold program code instructions to perform: identifying at least two clusters running at least two file servers (module 7B20); synchronizing, using a first set of network paths, the at least two file servers to maintain synchronized file system content at the at least two file servers (module 7B30); interfacing a file server witness to communicate, over a second set of network paths, to the at least two file servers (module 7B40); monitoring, by the file server witness, the at least two file servers to determine at least one status indicator associated with the at least two file servers (module 7B50); and directing at least one file I/O request to at least one of the at least two file servers, the at least one file I/O request being issued to access the file system content, and the at least one file I/O request being directed based at least in part on the at least one status indicator (module 7B60).

### System Architecture Overview

### Additional System Architecture Examples

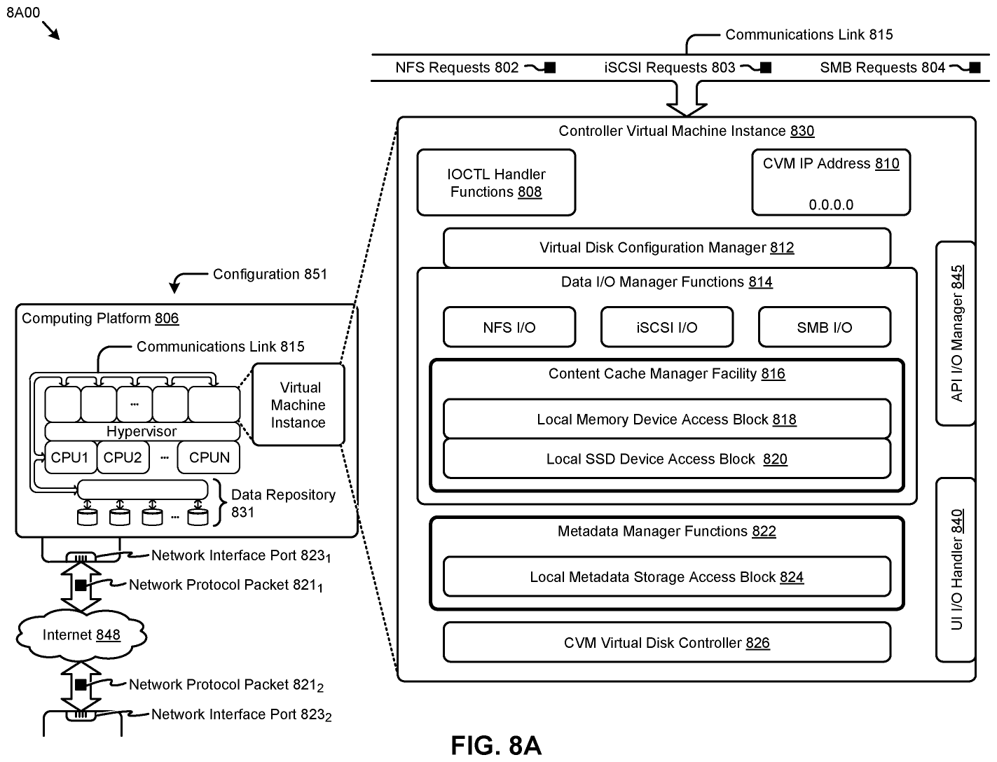

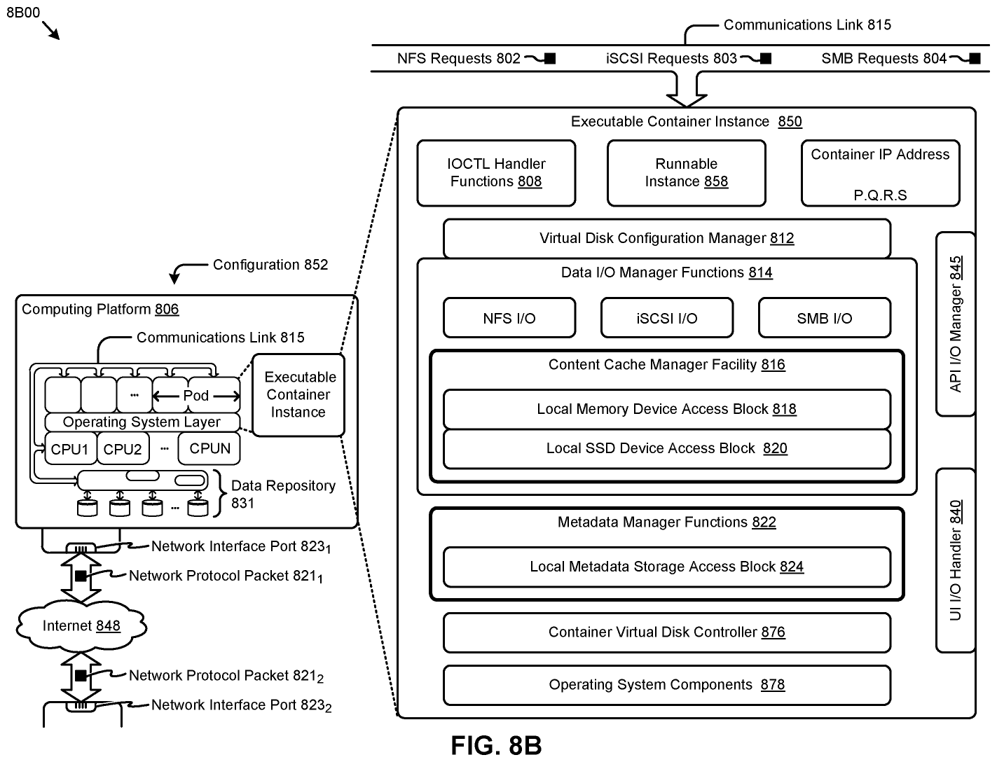

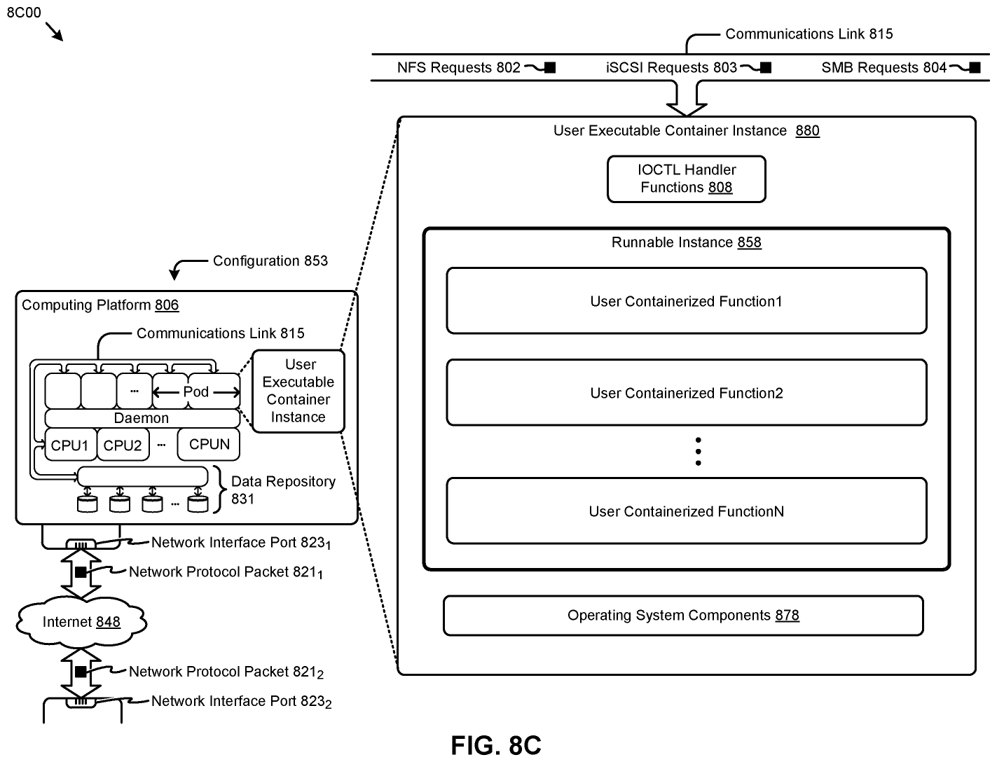

FIG. 8A depicts a virtualized controller as implemented by the shown virtual machine architecture 8A00. The heretofore-disclosed embodiments, including variations of any virtualized controllers, can be implemented in distributed systems where a plurality of networked-connected devices communicate and coordinate actions using inter-component messaging. Distributed systems are systems of interconnected components that are designed for, or dedicated to, storage operations as well as being designed for, or dedicated to, computing and/or networking operations. Interconnected components in a distributed system can operate cooperatively to achieve a particular objective, such as to provide high-performance computing, high-performance networking capabilities, and/or high-performance storage and/or high-capacity storage capabilities. For example, a first set of components of a distributed computing system can coordinate to efficiently use a set of computational or compute resources, while a second set of components of the same distributed storage system can coordinate to efficiently use a set of data storage facilities.

A hyperconverged system coordinates the efficient use of compute and storage resources by and between the components of the distributed system. Adding a hyperconverged unit to a hyperconverged system expands the system in multiple dimensions. As an example, adding a hyperconverged unit to a hyperconverged system can expand the system in the dimension of storage capacity while concurrently expanding the system in the dimension of computing capacity and also in the dimension of networking bandwidth. Components of any of the foregoing distributed systems can comprise physically and/or logically distributed autonomous entities.

Physical and/or logical collections of such autonomous entities can sometimes be referred to as nodes. In some hyperconverged systems, compute and storage resources can be integrated into a unit of a node. Multiple nodes can be interrelated into an array of nodes, which nodes can be grouped into physical groupings (e.g., arrays) and/or into logical groupings or topologies of nodes (e.g., spoke-and-wheel topologies, rings, etc.). Some hyperconverged systems implement certain aspects of virtualization. For example, in a hypervisor-assisted virtualization environment, certain of the autonomous entities of a distributed system can be implemented as virtual machines. As another example, in some virtualization environments, autonomous entities of a distributed system can be implemented as executable containers. In some systems and/or environments, hypervisor-assisted virtualization techniques and operating system virtualization techniques are combined.

As shown, virtual machine architecture 8A00 comprises a collection of interconnected components suitable for implementing embodiments of the present disclosure and/or for use in the herein-described environments. Moreover, virtual machine architecture 8A00 includes a virtual machine instance in configuration 851 that is further described as pertaining to controller virtual machine instance 830. Configuration 851 supports virtual machine instances that are deployed as user virtual machines, or controller virtual machines or both. Such virtual machines interface with a hypervisor (as shown). Some virtual machines include processing of storage I/O (input/output or IO) as received from any or every source within the computing platform. An example implementation of such a virtual machine that processes storage I/O is depicted as 830.

In this and other configurations, a controller virtual machine instance receives block I/O (input/output or IO) storage requests as network file system (NFS) requests in the form of NFS requests 802, and/or internet small computer storage interface (iSCSI) block IO requests in the form of iSCSI requests 803, and/or Samba file system (SMB) requests in the form of SMB requests 804. The controller virtual machine (CVM) instance publishes and responds to an internet protocol (IP) address (e.g., CVM IP address 810). Various forms of input and output (I/O or IO) can be handled by one or more IO control handler functions (e.g., IOCTL handler functions 808) that interface to other functions such as data IO manager functions 814 and/or metadata manager functions 822. As shown, the data IO manager functions can include communication with virtual disk configuration manager 812 and/or can include direct or indirect communication with any of various block IO functions (e.g., NFS IO, iSCSI IO, SMB IO, etc.).

In addition to block IO functions, configuration 851 supports IO of any form (e.g., block IO, streaming IO, packet-based IO, HTTP traffic, etc.) through either or both of a user interface (UI) handler such as UI IO handler 840 and/or through any of a range of application programming interfaces (APIs), possibly through API IO manager 845.

Communications link 815 can be configured to transmit (e.g., send, receive, signal, etc.) any type of communications packets comprising any organization of data items. The data items can comprise a payload data, a destination address (e.g., a destination IP address) and a source address (e.g., a source IP address), and can include various packet processing techniques (e.g., tunneling), encodings (e.g., encryption), and/or formatting of bit fields into fixed-length blocks or into variable length fields used to populate the payload. In some cases, packet characteristics include a version identifier, a packet or payload length, a traffic class, a flow label, etc. In some cases, the payload comprises a data structure that is encoded and/or formatted to fit into byte or word boundaries of the packet.

In some embodiments, hard-wired circuitry may be used in place of, or in combination with, software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions to a data processor for execution. Such a medium may take many forms including, but not limited to, non-volatile media and volatile media. Non-volatile media includes any non-volatile storage medium, for example, solid state storage devices (SSDs) or optical or magnetic disks such as hard disk drives (HDDs) or hybrid disk drives, or random access persistent memories (RAPMs) or optical or magnetic media drives such as paper tape or magnetic tape drives. Volatile media includes dynamic memory such as random access memory. As shown, controller virtual machine instance 830 includes content cache manager facility 816 that accesses storage locations, possibly including local dynamic random access memory (DRAM) (e.g., through local memory device access block 818) and/or possibly including accesses to local solid state storage (e.g., through local SSD device access block 820).

Common forms of computer readable media include any non-transitory computer readable medium, for example, floppy disk, flexible disk, hard disk, magnetic tape, or any other magnetic medium; CD-ROM or any other optical medium; punch cards, paper tape, or any other physical medium with patterns of holes; or any RAM, PROM, EPROM, FLASH-EPROM, or any other memory chip or cartridge. Any data can be stored, for example, in any form of data repository 831, which in turn can be formatted into any one or more storage areas, and which can comprise parameterized storage accessible by a key (e.g., a filename, a table name, a block address, an offset address, etc.). Data repository 831 can store any forms of data, and may comprise a storage area dedicated to storage of metadata pertaining to the stored forms of data. In some cases, metadata can be divided into portions. Such portions and/or cache copies can be stored in the storage data repository and/or in a local storage area (e.g., in local DRAM areas and/or in local SSD areas). Such local storage can be accessed using functions provided by local metadata storage access block 824. The data repository 831 can be configured using CVM virtual disk controller 826, which can in turn manage any number or any configuration of virtual disks.

Execution of the sequences of instructions to practice certain embodiments of the disclosure are performed by one or more instances of a software instruction processor, or a processing element such as a data processor, or such as a central processing unit (e.g., CPU1, CPU2, . . . , CPUN). According to certain embodiments of the disclosure, two or more instances of configuration 851 can be coupled by communications link 815 (e.g., backplane, LAN, PSTN, wired or wireless network, etc.) and each instance may perform respective portions of sequences of instructions as may be required to practice embodiments of the disclosure.

The shown computing platform 806 is interconnected to the Internet 848 through one or more network interface ports (e.g., network interface port 823₁ and network interface port 823₂). Configuration 851 can be addressed through one or more network interface ports using an IP address. Any operational element within computing platform 806 can perform sending and receiving operations using any of a range of network protocols, possibly including network protocols that send and receive packets (e.g., network protocol packet 821₁ and network protocol packet 821₂).

Computing platform 806 may transmit and receive messages that can be composed of configuration data and/or any other forms of data and/or instructions organized into a data structure (e.g., communications packets). In some cases, the data structure includes program code instructions (e.g., application code) communicated through the Internet 848 and/or through any one or more instances of communications link 815. Received program code may be processed and/or executed by a CPU as it is received and/or program code may be stored in any volatile or non-volatile storage for later execution. Program code can be transmitted via an upload (e.g., an upload from an access device over the Internet 848 to computing platform 806). Further, program code and/or the results of executing program code can be delivered to a particular user via a download (e.g., a download from computing platform 806 over the Internet 848 to an access device).

Configuration 851 is merely one sample configuration. Other configurations or partitions can include further data processors, and/or multiple communications interfaces, and/or multiple storage devices, etc. within a partition. For example, a partition can bound a multi-core processor (e.g., possibly including embedded or collocated memory), or a partition can bound a computing cluster having a plurality of computing elements, any of which computing elements are connected directly or indirectly to a communications link. A first partition can be configured to communicate to a second partition. A particular first partition and a particular second partition can be congruent (e.g., in a processing element array) or can be different (e.g., comprising disjoint sets of components).

A cluster is often embodied as a collection of computing nodes that can communicate between each other through a local area network (e.g., LAN or virtual LAN (VLAN)) or a backplane. Some clusters are characterized by assignment of a particular set of the aforementioned computing nodes to access a shared storage facility that is also configured to communicate over the local area network or backplane. In many cases, the physical bounds of a cluster are defined by a mechanical structure such as a cabinet or such as a chassis or rack that hosts a finite number of mounted-in computing units. A computing unit in a rack can take on a role as a server, or as a storage unit, or as a networking unit, or any combination therefrom. In some cases, a unit in a rack is dedicated to provisioning of power to other units. In some cases, a unit in a rack is dedicated to environmental conditioning functions such as filtering and movement of air through the rack and/or temperature control for the rack. Racks can be combined to form larger clusters. For example, the LAN of a first rack having a quantity of 32 computing nodes can be interfaced with the LAN of a second rack having 16 nodes to form a two-rack cluster of 48 nodes. The former two LANs can be configured as subnets, or can be configured as one VLAN. Multiple clusters can communicate between one module to another over a WAN (e.g., when geographically distal) or a LAN (e.g., when geographically proximal).

A module as used herein can be implemented using any mix of any portions of memory and any extent of hard-wired circuitry including hard-wired circuitry embodied as a data processor. Some embodiments of a module include one or more special-purpose hardware components (e.g., power control, logic, sensors, transducers, etc.). A data processor can be organized to execute a processing entity that is configured to execute as a single process or configured to execute using multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

Some embodiments of a module include instructions that are stored in a memory for execution so as to facilitate operational and/or performance characteristics pertaining to fault tolerant access to file servers in multi-cluster computing environments. In some embodiments, a module may include one or more state machines and/or combinational logic used to implement or facilitate the operational and/or performance characteristics pertaining to fault tolerant access to file servers in multi-cluster computing environments.

Various implementations of the data repository comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects of fault tolerant access to file servers in multi-cluster computing environments). Such files or records can be brought into and/or stored in volatile or non-volatile memory. More specifically, the occurrence and organization of the foregoing files, records, and data structures improve the way that the computer stores and retrieves data in memory, for example, to improve the way data is accessed when the computer is performing operations pertaining to fault tolerant access to file servers in multi-cluster computing environments, and/or for improving the way data is manipulated when performing computerized operations pertaining to implementing a high-availability file server capability by automatically directing file I/O requests to one of two or more synchronized file servers in accordance with the then-current status (e.g., health) of the file servers.

Further details regarding general approaches to managing data repositories are described in U.S. Pat. No. 8,601,473 titled “ARCHITECTURE FOR MANAGING I/O AND STORAGE FOR A VIRTUALIZATION ENVIRONMENT”, issued on Dec. 3, 2013, which is hereby incorporated by reference in its entirety.

Further details regarding general approaches to managing and maintaining data in data repositories are described in U.S. Pat. No. 8,549,518 titled “METHOD AND SYSTEM FOR IMPLEMENTING A MAINTENANCE SERVICE FOR MANAGING I/O AND STORAGE FOR A VIRTUALIZATION ENVIRONMENT”, issued on Oct. 1, 2013, which is hereby incorporated by reference in its entirety.

FIG. 8B depicts a virtualized controller implemented by containerized architecture 8B00. The containerized architecture comprises a collection of interconnected components suitable for implementing embodiments of the present disclosure and/or for use in the herein-described environments. Moreover, the shown containerized architecture 8B00 includes an executable container instance in configuration 852 that is further described as pertaining to executable container instance 850. Configuration 852 includes an operating system layer (as shown) that performs addressing functions such as providing access to external requestors via an IP address (e.g., “P.Q.R.S”, as shown). Providing access to external requestors can include implementing all or portions of a protocol specification (e.g., “http:”) and possibly handling port-specific functions.

The operating system layer can perform port forwarding to any executable container (e.g., executable container instance 850). An executable container instance can be executed by a processor. Runnable portions of an executable container instance sometimes derive from an executable container image, which in turn might include all, or portions of any of, a Java archive repository (JAR) and/or its contents, and/or a script or scripts and/or a directory of scripts, and/or a virtual machine configuration, and may include any dependencies therefrom. In some cases, a configuration within an executable container might include an image comprising a minimum set of runnable code. Contents of larger libraries and/or code or data that would not be accessed during runtime of the executable container instance can be omitted from the larger library to form a smaller library composed of only the code or data that would be accessed during runtime of the executable container instance. In some cases, start-up time for an executable container instance can be much faster than start-up time for a virtual machine instance, at least inasmuch as the executable container image might be much smaller than a respective virtual machine instance. Furthermore, start-up time for an executable container instance can be much faster than start-up time for a virtual machine instance, at least inasmuch as the executable container image might have many fewer code and/or data initialization steps to perform than a respective virtual machine instance.

An executable container instance (e.g., a Docker container instance) can serve as an instance of an application container or as a controller executable container. Any executable container of any sort can be rooted in a directory system, and can be configured to be accessed by file system commands (e.g., “Is” or “Is-a”, etc.). The executable container might optionally include operating system components 878, however such a separate set of operating system components need not be provided. As an alternative, an executable container can include runnable instance 858, which is built (e.g., through compilation and linking, or just-in-time compilation, etc.) to include all of the library and OS-like functions needed for execution of the runnable instance. In some cases, a runnable instance can be built with a virtual disk configuration manager, any of a variety of data IO management functions, etc. In some cases, a runnable instance includes code for, and access to, container virtual disk controller 876. Such a container virtual disk controller can perform any of the functions that the aforementioned CVM virtual disk controller 826 can perform, yet such a container virtual disk controller does not rely on a hypervisor or any particular operating system so as to perform its range of functions.

In some environments, multiple executable containers can be collocated and/or can share one or more contexts. For example, multiple executable containers that share access to a virtual disk can be assembled into a pod (e.g., a Kubernetes pod). Pods provide sharing mechanisms (e.g., when multiple executable containers are amalgamated into the scope of a pod) as well as isolation mechanisms (e.g., such that the namespace scope of one pod does not share the namespace scope of another pod).

FIG. 8C depicts a virtualized controller implemented by a daemon-assisted containerized architecture 8C00. The containerized architecture comprises a collection of interconnected components suitable for implementing embodiments of the present disclosure and/or for use in the herein-described environments. Moreover, the shown daemon-assisted containerized architecture includes a user executable container instance in configuration 853 that is further described as pertaining to user executable container instance 880. Configuration 853 includes a daemon layer (as shown) that performs certain functions of an operating system.

User executable container instance 880 comprises any number of user containerized functions (e.g., user containerized function1, user containerized function2, . . . , user containerized functionN). Such user containerized functions can execute autonomously, or can be interfaced with or wrapped in a runnable object to create a runnable instance (e.g., runnable instance 858). In some cases, the shown operating system components 878 comprise portions of an operating system, which portions are interfaced with or included in the runnable instance and/or any user containerized functions. In this embodiment of a daemon-assisted containerized architecture, the computing platform 806 might or might not host operating system components other than operating system components 878. More specifically, the shown daemon might or might not host operating system components other than operating system components 878 of user executable container instance 880.

The virtual machine architecture 8A00 of FIG. 8A and/or the containerized architecture 8B00 of FIG. 8B and/or the daemon-assisted containerized architecture 8C00 of FIG. 8C can be used in any combination to implement a distributed platform that contains multiple servers and/or nodes that manage multiple tiers of storage where the tiers of storage might be formed using the shown data repository 831 and/or any forms of network accessible storage. As such, the multiple tiers of storage may include storage that is accessible over communications link 815. Such network accessible storage may include cloud storage or networked storage (e.g., a SAN or “storage area network”). Unlike prior approaches, the presently-discussed embodiments permit local storage that is within or directly attached to the server or node to be managed as part of a storage pool. Such local storage can include any combinations of the aforementioned SSDs and/or HDDs and/or RAPMs and/or hybrid disk drives. The address spaces of a plurality of storage devices, including both local storage (e.g., using node-internal storage devices) and any forms of network-accessible storage, are collected to form a storage pool having a contiguous address space.

Significant performance advantages can be gained by allowing the virtualization system to access and utilize local (e.g., node-internal) storage. This is because I/O performance is typically much faster when performing access to local storage as compared to performing access to networked storage or cloud storage. This faster performance for locally attached storage can be increased even further by using certain types of optimized local storage devices, such as SSDs or RAPMs, or hybrid HDDs or other types of high-performance storage devices.

In example embodiments, each storage controller exports one or more block devices or NFS or iSCSI targets that appear as disks to user virtual machines or user executable containers. These disks are virtual since they are implemented by the software running inside the storage controllers. Thus, to the user virtual machines or user executable containers, the storage controllers appear to be exporting a clustered storage appliance that contains some disks. User data (including operating system components) in the user virtual machines resides on these virtual disks.

Any one or more of the aforementioned virtual disks (or “vDisks”) can be structured from any one or more of the storage devices in the storage pool. As used herein, the term vDisk refers to a storage abstraction that is exposed by a controller virtual machine or container to be used by another virtual machine or container. In some embodiments, the vDisk is exposed by operation of a storage protocol such as iSCSI or NFS or SMB. In some embodiments, a vDisk is mountable. In some embodiments, a vDisk is mounted as a virtual storage device.

In example embodiments, some or all of the servers or nodes run virtualization software. Such virtualization software might include a hypervisor (e.g., as shown in configuration 851 of FIG. 8A) to manage the interactions between the underlying hardware and user virtual machines or containers that run client software.

Distinct from user virtual machines or user executable containers, a special controller virtual machine (e.g., as depicted by controller virtual machine instance 830) or as a special controller executable container is used to manage certain storage and I/O activities. Such a special controller virtual machine is referred to as a “CVM”, or as a controller executable container, or as a service virtual machine “SVM”, or as a service executable container, or as a “storage controller”. In some embodiments, multiple storage controllers are hosted by multiple nodes. Such storage controllers coordinate within a computing system to form a computing cluster.

The storage controllers are not formed as part of specific implementations of hypervisors. Instead, the storage controllers run above hypervisors on the various nodes and work together to form a distributed system that manages all of the storage resources, including the locally attached storage, the networked storage, and the cloud storage. In example embodiments, the storage controllers run as special virtual machines—above the hypervisors'thus, the approach of using such special virtual machines can be used and implemented within any virtual machine architecture. Furthermore, the storage controllers can be used in conjunction with any hypervisor from any virtualization vendor and/or implemented using any combinations or variations of the aforementioned executable containers in conjunction with any host operating system components.

In the foregoing specification, the disclosure has been described with reference to specific embodiments thereof. It will however be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are to be regarded in an illustrative sense rather than in a restrictive sense.

1. (canceled)

2. A method, comprising:
implementing, using a first virtual machine, a first file server in a first failure domain to provide file services;
implementing, using a second virtual machine, a second file server in a second failure domain to provide the file services, wherein a failure affecting the first failure domain does not affect the second failure domain;
generating monitoring results by respectively monitoring the first and the second file servers, wherein said monitoring is performed with at least one system monitor in at least one of the first and second failure domains, and the at least one system monitor is external to the first and the second file servers; and
implementing a witness external to the first and second failure domains, wherein the witness is in communication with the at least one system monitor and executes an operation to select either the first file server or the second file server to serve as a primary file server after detecting an operational status from the monitoring results.

3. The method of claim 2, wherein the first file server in the first failure domain synchronously replicates data to the second file server in the second failure domain, or the first file server at the first failure domain and the second file server at the second failure domain store file services content in a distributed storage pool.

4. The method of claim 2, wherein the first file server in the first failure domain corresponds to a primary file server and is transitioned from a primary mode into a fail mode, and the second file server at the second failure domain corresponds to a secondary file server and is transitioned from a replication mode into the primary mode.

5. The method of claim 4, wherein the first file server at the first failure domain, after remediation, is transitioned from the fail mode into the replication mode while the second file server at the second failure domain remains in the primary mode, the witness is in a third failure domain, and the witness is implemented as a third virtual machine.

6. The method of claim 2, wherein the witness is in a third failure domain external to the first failure domain and the second failure domain, wherein the witness receives the operational status from the at least one system monitor, the first virtual machine or the second virtual machine is of a first type of virtual machines, and the witness is implemented in a separate virtual machine of a second type that is different from the first type.

7. The method of claim 2, wherein the at least one system monitor receives a heartbeat corresponding to the first file server in the first failure domain, wherein the heartbeat is used to monitor availability of the first file server at the first failure domain.

8. The method of claim 2, wherein a plurality of file servers including the first file server in the first failure domain and the second file server in the second failure domain are registered with the witness, and the witness bridges one or more hosts with the plurality of file servers in multiple clusters to provide the file services to the one or more hosts.

9. The method of claim 2, wherein the first file server in the first failure domain is in a first cluster and the second file server in the second failure domain is in a second cluster.

10. The method of claim 2, wherein each of the first failure domain and the second failure domain respectively corresponds to a logical collection of hardware components that are commonly affected by a failure within the logical collection.

11. A system, comprising:
a processor;
a memory for holding programmable code, wherein the programmable code includes instructions which, when executed by the processor, causes the processor to perform a set of acts, the set of acts comprising:
implementing, using a first virtual machine, a first file server in a first failure domain to provide file services;
implementing, using a second virtual machine, a second file server in a second failure domain to provide the file services, wherein a failure affecting the first failure domain does not affect the second failure domain;
generating monitoring results by respectively monitoring the first and the second file servers, wherein said monitoring is performed with at least one system monitor in at least one of the first and second domains, and the at least one system monitor is external to the first and second file servers; and
implementing a witness external to the first and second failure domains, wherein the witness is in communication with the at least one system monitor and executes an operation to select either the first or the second file server to serve as a primary file server after detecting an operational status from the monitoring results.

12. The system of claim 11, wherein the first file server in the first failure domain synchronously replicates data to the second file server in the second failure domain, or the first file server at the first failure domain and the second file server at the second failure domain store file services content in a distributed storage pool.

13. The system of claim 11, wherein the first file server in the first failure domain corresponds to a primary file server and is transitioned from a primary mode into a fail mode, and the second file server in the second failure domain corresponds to a secondary file server and is transitioned from a replication mode into the primary mode.

14. The system of claim 13, wherein the first file server in the first failure domain, after remediation, is transitioned from the fail mode into the replication mode while the second file server in the second failure domain remains in the primary mode, the witness is in a third failure domain, and the witness is implemented as a third virtual machine.

15. The system of claim 11, wherein the witness is in a third failure domain external to the first and second domains, wherein the witness receives the operational status from the at least one system monitor, the first virtual machine or the second virtual machine is of a first type of virtual machines, and the witness is implemented in a separate virtual machine of a second type that is different from the first type.

16. The system of claim 11, wherein the at least one system monitor receives a heartbeat corresponding to the first file server in the first failure domain, wherein the heartbeat is used to monitor availability of the first file server in the first failure domain.

17. The system of claim 11, wherein a plurality of file servers including the first file server in the first failure domain and the second file server in the second failure domain are registered with the witness, and the witness bridges one or more hosts with the plurality of file servers in multiple clusters to provide the file services to the one or more hosts.

18. The system of claim 11, wherein the first file server in the first failure domain is in a first cluster and the second file server in the second failure domain is in a second cluster.

19. The system of claim 11, wherein each of the first failure domain and the second failure domain respectively corresponds to a logical collection of hardware components that are commonly affected by a failure within the logical collection.

20. A computer program product embodied on a non-transitory computer readable medium having stored thereon a sequence of instructions which, when executed by a processor, causes the processor to execute a set of acts, the set of acts comprising:
implementing, using a first virtual machine, a first file server in a first failure domain to provide file services;
implementing, using a first virtual machine, a second file server in a second failure domain to provide the file services, wherein a failure affecting the first failure domain does not affect the second failure domain;
generating monitoring results by respectively monitoring the first and the second file servers, wherein said monitoring is performed with at least one system monitor in at least one of the first and second failure domains, and the at least one system monitor is external to the first and second file servers; and
implementing a witness external to the first and second failure domains, wherein the witness is in communication with the at least one system monitor and executes an operation to select either the first file server or the second file server to serve as a primary file server after detecting an operational status from the monitoring results.

21. The computer program product of claim 20, wherein the first file server in the first failure domain synchronously replicates data to the second file server in the second failure domain, or the first file server at the first site and the second file server in the second failure domain store file services content in a distributed storage pool.

22. The computer program product of claim 20, wherein the first file server in the first failure domain corresponds to a primary file server and is transitioned from a primary mode into a fail mode, and the second file server in the second failure domain corresponds to a secondary file server and is transitioned from a replication mode into the primary mode.

23. The computer program product of claim 22, wherein the first file server in the first failure domain, after remediation, is transitioned from the fail mode into the replication mode while the second file server in the second remains in the primary mode, the witness is in a third failure domain, and the witness is implemented as a third virtual machine.

24. The computer program product of claim 20, wherein the witness is in a third failure domain external to the first and second domains, wherein the witness receives the operational status from the at least one system monitor, the first virtual machine or the second virtual machine is of a first type of virtual machines, and the witness is implemented in a third virtual machine of a second type that is different from the first type.

25. The computer program product of claim 20, wherein the at least one system monitor receives a heartbeat corresponding to the first file server in the first failure domain, wherein the heartbeat is used to monitor availability of the first file server in the first failure domain.

26. The computer program product of claim 20, wherein a plurality of file servers including the first file server in the first failure domain and the second file server in the second failure domain are registered with the witness, and the witness bridges one or more hosts with the plurality of file servers in multiple clusters to provide the file services to the one or more hosts.

27. The computer program product of claim 20, wherein the first file server in the first failure domain is in a first cluster and the second file server in the second failure domain is in a second cluster.

28. The computer program product of claim 20, wherein each of the first failure domain and the second failure domain respectively correspond to a logical collection of hardware components that are commonly affected by a failure within the logical collection.

29. The method of claim 2, wherein the witness is in a third failure domain external to the first failure domain and the second failure domain.

30. The method of claim 29, wherein the first file server is in a first cluster in the first failure domain, the second file server is in a second cluster in the second failure domain, and the witness is in a third cluster in a third failure domain, wherein the third failure domain is separate from and external to the first failure domain and the second failure domain.

31. The method of claim 2, the at least one system monitor comprising a first system monitor and a second system monitor, wherein
the first failure domain comprises the first system monitor that is in communication with the witness,
the second failure domain comprises the second system monitor that is in communication with the witness,
the first system monitor of the first failure domain is external to and in communication with the first file server,
the second system monitor of the second failure domain is external to and in communication with the second file server, and
results are generated by respectively monitoring the first and second file servers with respective first and second system monitors.

32. The method of claim 31, wherein
the first system monitor is deployed in a first controller virtual machine of a first cluster of the first failure domain,
a second system monitor is deployed in a second controller virtual machine of a second cluster of the second failure domain, and
each of the first and second controller virtual machines is in communication with the witness.

33. The method of claim 2, wherein
the first failure domain comprises a first system monitor and the second failure domain comprises a second system monitor,
the first system monitor of the first failure domain is external to and in communication with the first file server and the witness, the first system monitor receiving a first heartbeat corresponding the first file server,
the second system monitor of the second failure domain is external to and in communication with the second file server and the witness, the second system monitor receiving a second heartbeat corresponding to the second file server, and
the witness executes an operation to select either the first file server or the second file server based at least in part on respective first and second heartbeats and respective availabilities of respective first and second servers.
